(19) United States
(12) Patent Application Publication
(10) Pub. No.: US 2005/0177358 A1
(43) Pub. Date: Aug. 11, 2005

(54) Multilingual database interaction system and method

(76) Inventors: Edward Melomed, Kirkland, WA (US); Alexander Berger, Sammamish, WA (US); Amir Netz, Bellevue, WA (US); Ariel Netz, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/775,612

(22) Filed: Feb. 10, 2004

(51) Int. Cl. G06F 17/28

(52) U.S. Cl. 704/2

(57) ABSTRACT

The present invention relates to a system and method of translating stored data. In particular the present invention facilitates multilingual interaction with a data store by providing a translation component between data stored in one language and users that prefer to interact in one or more different languages. Queries or commands can be executed on a database and results presented in any one of a plurality of languages selected by a user. Furthermore, a mechanism is also provided to allow users to enter queries in their preferred language rather than the language of the underlying system.

### TECHNICAL FIELD

The present invention relates generally to databases and more particularly toward translation of data and metadata stored therein.

### BACKGROUND

Databases are organized collections of related information or data. As is known in the art, there are several ways to organize and analyze data. Traditional relational databases store data in a plurality of related tables. Tables contain a series of rows also referred to as records. Each row provides particular information about a particular thing such as a customer. Rows are divided into sections called columns. The intersection between a row and column is referred to as a field. Each field provides data or information related to a particular thing. The columns specify the particular type of data provided in each field. For example, a table of be established for purchases or a particular product. The table can include a plurality of rows corresponding to individual customers, and several columns for first name, last name, address, state, zip code, number of products purchased, price, date, etc.

Online application processing (OLAP) is a data technology that facilitates analysis of multidimensional data models. In OLAP, data is represented conceptually as a cube. A cube is an organized hierarchy of categories or levels. Categories typically describe a similar set of members upon which an end user wants to base an analysis. A dimension is a structural attribute of a cube which defines a category. For example, a dimension may be time which can include an organized hierarchy of levels such as year, month, and day. Additionally a dimension may be geography which can include levels such as country, state, and city. Cubes contain measures, which are sets of values based on a column in the cube's fact table. Typically, numeric measures are the central values of a cube that are analyzed. That is, measures are the data of primary interest to end users browsing or querying a cube. The measures selected depend on the types of information end users request. Some common measures are sales, cost, expenditures, and production count. For each measure in a cube, the cube contains a value for every cell in the cube.

Databases, regardless of type, are popular and useful because of their ability to store large amounts of data that can be easily retrieved and manipulated. All database systems, therefore, include database engines that provide the means to retrieve and manipulate database data. Typically, database engines provide resulting data from a database in response to a structured query. Both the query and the resulting data are typically presented in a single base language, such as English. However, many companies and entities that utilize database systems have employees or associates that are either not fluent in the base language of the database or are more comfortable utilizing another language. For example, many companies that utilize databases have offices in several countries around the world or have a multilingual population. A conventional solution to such a predicament is to produce numerous individual databases for each of a myriad of different languages each containing the same information. However, while enabling users to interact with data in a language they are most comfortable with, the conventional solution is very inefficient and expensive to implement and maintain as additional resources such as additional hardware and management are needed. Furthermore, changes in one database need to be permeated to the numerous other language databases to ensure that everyone is working with the same data. Such a task is often difficult to accomplish.

Accordingly, there is a need in the art for new system and method that facilitates multilingual access and interaction with database data.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present system and method facilitates interaction with a database in a plurality of different languages. In particular the present invention provides for a translation mechanism for storing and interacting with data in a user preferred language. According to one aspect of the subject invention, a database can have a translation component placed between the database and a user to facilitate translation of data objects (e.g., data and metadata) from a base language in which they are stored to a user preferred language. Thus, users can enter database queries and receive the resulting data in the language in which they are most comfortable. Furthermore, all users regardless of their chosen presentation language can view exactly the same data source. Accordingly, there is no need to maintain separate databases for each user language, and there is no need to be concerned with ensuring that each separate database contains the same information.

According to an aspect of the invention, the translation component can convert data and/or metadata to a plurality of different languages by employing translation tables. Translation tables can comprise translation information regarding all the information stored in the database with which they are associated. Each translation table can correspond to a distinct language (e.g., Russian, English, German, Chinese . . . ). A mapping component can then map data objects to their particular translation in a particular translation table to produce the correct translation.

According to another aspect of the invention, a translation component can convert data and/or metadata dynamically. Thus, each resulting data object can be translated in real time as it is produced. For instance, a context component and one or more dictionary components can be employed. The context component can analyze contextual information about the data object such as the metadata associated therewith. The dictionary component(s) can comprise information regarding translations of various words from one language to another. Together the context component and dictionary components can produce translations of data objects.

According to yet another aspect of the present invention, query information can be accepted in a plurality of different formats and languages. For instance, a query can be entered in structured query format in English or French or Russian. Alternatively, a query can simply be entered in natural language in Japanese, Chinese, or Italian, for example. Thus, the present invention does not bind the user to a structured query in the language of the database system (e.g., English).

According to still another aspect of the invention, a user can specify collation information to indicate to a database how resulting data is to be presented. For example, a user can specify that data be sorted in the base language of the system or in a selected presentation language. Furthermore, a user can indicated whether at is to be sorted ascending or descending and whether such sorting should be case sensitive.

In accordance with yet another aspect of the present invention, databases can be defined, created, and/or manipulated utilizing the translation system and method disclosed herein. Thus, users can input commands, operators, and data in their preferred language. The translation component can subsequently translate the input and provide the input instructions to a database management system for execution.

Accordingly, the system and method of the subject invention provides for translations and allows users to easily and seamlessly switch from one language to another. Having such a translation mechanism can allow corporations in different countries or in a single country with a multilingual population to build a single unified view to data. For example, assume that XYZ Company operates in France, Germany, Spain as well as the United States. For such a company, it is essential to be able to represent a unified view in terms of geography, product, and time. Representatives of the XYZ Company will not be required to be able to understand a plurality of different languages all at once. With translations for a geography dimension, for a product dimension and for a time dimension specified into all languages every person in each country is able to work in their preferred language with exactly the same dimensional model, send queries to exactly the same physical place and therefore get the same results.

To the accomplishment of the foregoing and related ends, certain illustrative aspects of the invention are described herein in connection with the following description and the annexed drawings. These aspects are indicative of various ways in which the invention may be practiced, all of which are intended to be covered by the present invention. Other advantages and novel features of the invention may become apparent from the following detailed description of the invention when considered in conjunction with the drawings.

### BRIEF DESCRIPTION OF THE DRAWINGS

The foregoing and other aspects of the invention will become apparent from the following detailed description and the appended drawings described in brief hereinafter.

FIG. 1 is a schematic block diagram of database translation system in accordance with an aspect of the subject invention.

FIG. 2 is a schematic block diagram of an interface component in accordance with an aspect of the subject invention.

FIG. 3 is a schematic block diagram of a translation component in accordance with an aspect of the present invention.

FIG. 4 is a schematic block diagram of an inference component in accordance with an aspect of the subject invention.

FIG. 5 is a schematic block diagram of a database translation system in accordance with an aspect of the subject invention

FIG. 6 is a schematic block diagram of a query generation system in accordance with an aspect of the present invention.

FIG. 7 is a schematic block diagram of a database interaction system in accordance with an aspect of the subject invention.

FIG. 8 is a flow chart diagram of a database translation methodology in accordance with an aspect of the present invention.

FIG. 9 is a flow chart diagram of a database query methodology in accordance with an aspect of the subject invention.

FIG. 10 is a flow chart diagram of a method of interacting with a database translation system in accordance with an aspect of the subject invention.

FIG. 11 is a flow chart diagram of a method for interacting with a database in accordance with an aspect of the present invention.

FIG. 12 is a schematic block diagram illustrating a suitable operating environment in accordance with an aspect of the present invention.

FIG. 13 is a schematic block diagram of a sample-computing environment with which the present invention can interact.

### DETAILED DESCRIPTION

The present invention is now described with reference to the annexed drawings, wherein like numerals refer to like elements throughout. It should be understood, however, that the drawings and detailed description thereto are not intended to limit the invention to the particular form disclosed. Rather, the intention is to cover all modifications, equivalents, and alternatives falling within the spirit and scope of the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. Of course, those skilled in the art will recognize many modifications may be made to this configuration without departing from the scope or spirit of the subject invention.

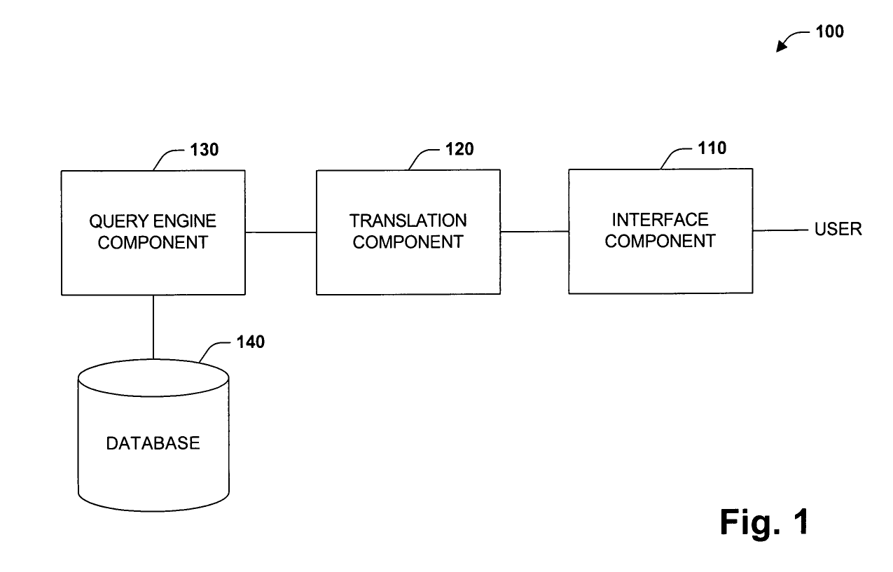

FIG. 1 depicts a database translation system 100 in accordance with an aspect of the subject invention. Database translation system 100 comprises an interface component 110, a translation component 120, a query engine component 130, and a database 140. Interface component 110 is a mechanism for receiving queries from users and presenting users with result data. In particular, interface component 110 is able to receive queries from a user in a number of different formats, the simplest being a structured query format in the base language of the system (e.g., Sales 12/1995, bicycles). Interface component 110 passes the query along with other information, for example an indication of the preferred language of a user, to the translation component 120. If the query has not been provided in a structured query language form in the base language of the system then translation component 120 can translate and/or convert the input data into an acceptable system format (described in further detail supra) and then pass the query to the query engine component 130. Query engine component 130 executes the query on the database 140. Database 140 is a repository for data of interest. According to an aspect of the invention, database 140 can be a multidimensional database such as an online analytical processing (OLAP) database. For example, a sales cube can be queried by a user. However, it should be noted that the invention is not limited to an analytic database. Query engine component 130 retrieves result data or data objects from database 140 and can then pass the data objects back to the translation component 120. Translation component 120 can subsequently identify the preferred user presentation language and translate data and associated metadata to the preferred language. The translated data can then be provided to the user via user interface 110. It should be appreciated that only a single database or group of databases is utilized in accordance with an aspect of the present invention, rather than a plurality of databases with data stored therein translated into a particular language (e.g., Russian, French, Spanish, German, Chinese . . . ). This ensures that every user, regardless of preferred presentation language, is interacting and viewing the same data as every other user. Thus, people in other countries around the world can easily access the same data regardless of the language in which that data was originally stored.

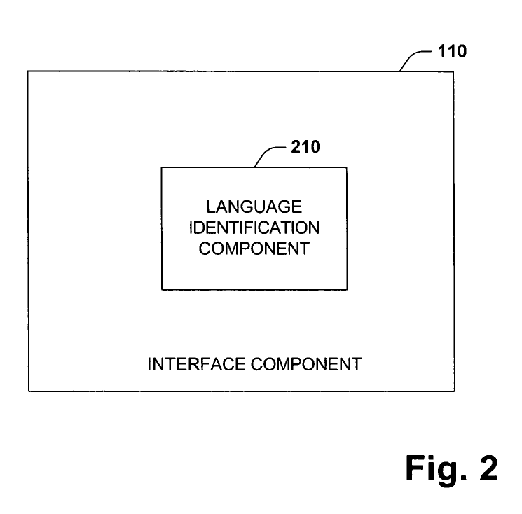

FIG. 2 depicts an interface component 110 in further detail in accordance with an aspect of the subject invention. Interface component 110 can include, inter alia, a language identification component 210. In addition to facilitating communication between a user and the system of the present invention, interface component 110 can also retrieve some information from a user. Language identification component 210 provides a mechanism for determining a user's preferred presentation language with which he/she desires to utilize when interacting with the system. According to one aspect of the invention, the user can simply be prompted to indicate their language of choice utilizing a graphical user interface dialog box, for instance. Alternatively, the language identification component 210 could retrieve such information from a local data store associated with a user's computer system or applications residing thereon. Still further yet, the language identification component 210 could analyze the users input to determine their preferred presentation language. For example, if a user requests information or specifies a query in German then the preferred language can be set to German. Thereafter, whenever a user employs the system data can be provided to them in accordance with there preferred language. However, a user can change their preferred presentation language at any time, for instance by changing the settings in a control panel associated with the database translation system.

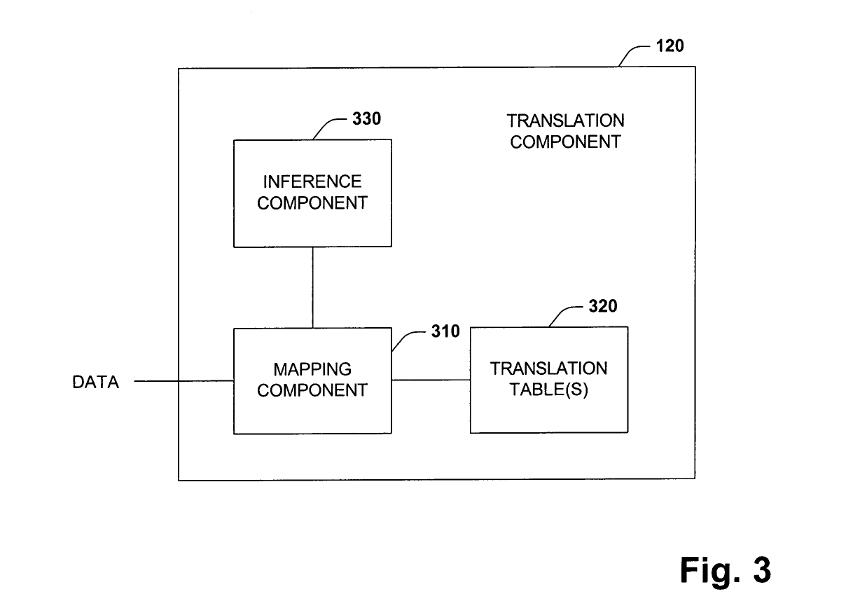

Turning to FIG. 3, a translation component 120 is illustrated in further detail in accordance with an aspect of the present invention. Translation component 120 comprises a mapping component 310, translation tables 320, and inference component 330. Mapping component 310 can receive information or data from a database 140 (FIG. 1), for example, in accordance with a user request or query. Upon receipt of the resulting data, mapping component 310 can determine which language resulting data or data objects should be translated to, if any. For example, information regarding a preferred presentation language can be received and transmitted to the mapping component along with a query from the interface component 110 (FIGS. 1 & 2).

Translation tables 320 can be utilized to facilitate translation of the resulting data objects. A translation table 320 can be provided for each language that is supported by the translation system. The tables can contain translations for both data as well as metadata objects stored in a database. Metadata is simply information describing data. For instance, in a multidimensional database one dimension can correspond to time. Thus, there may be columns in the database corresponding the year, month, and day. Such information will be stored in the base language of the database system (e.g., English). Therefore, this data or information should be translated to a specified presentation language to provide users with a complete and comprehensible result. Accordingly, if the result returned in response to a query is a table, then the metadata or structural information about the data such as the column and row names should be translated as well as the data stored in the cells associated with the structure. The metadata and data residing in translation table(s) 320 can be provided and maintained by a database administrator, for instance. Hence, if a new product is added to a database then a database administrator can update all the translation tables 320 to include this product's name in all supported languages. The result data and metadata received by the mapping component 310 can be mapped to a translation table to facilitate translation thereof and subsequently provided to a user via an interface component 110 (FIG. 1).

It should be appreciated that translation component 120 can also comprise an inference component 330 to facilitate data translation. Inference component 330 can be utilized for dynamic translation of data (or metadata) received by mapping component 310. Interface component can, according to an aspect of the invention completely replace the tables 320 as a mechanism for translation or simply supplement the tables 320. For instance, if new data has been added to a database and an administrator did not update the tables prior to a user query then the inference component 330 can be employed by mapping component 310 to infer the proper translation of resulting data.

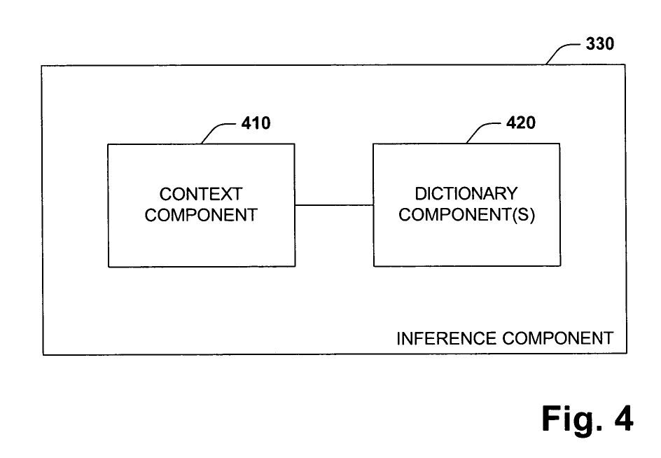

Turning briefly to FIG. 4, an inference component 310 is depicted in further detail in accordance with an aspect of the invention. Inference component 310 can comprise a context component 410 and dictionary component(s) 420. Context component 410 can receive text or a string of text from the mapping component for dynamic translation into the base language of the database system. Context component 410 can also receive and/or retrieve additional information associated with the text or string to be translated. Such information can provide a context for the text to be translated and thereby enable a more accurate translation. For example, context component 410 could receive metadata associated with the text. Such metadata could describe the text as a product for sale by a certain company. Context component 410 armed with context information can then utilized one or more dictionary component(s) 420 to determine the best translation for the text or string. Dictionary component(s) 420 can provide information regarding translations such as English to German and German to English. Hence the context component 410 can utilize the dictionary components to look up the translation from English to German and if there are several different translations context information can be utilized along with another dictionary component 420 such as a German to English dictionary to determine the most accurate translation. If a translation cannot be found within a certain degree of confidence a database administer may be notified, for instance to select or input a translation or particular unknown word.

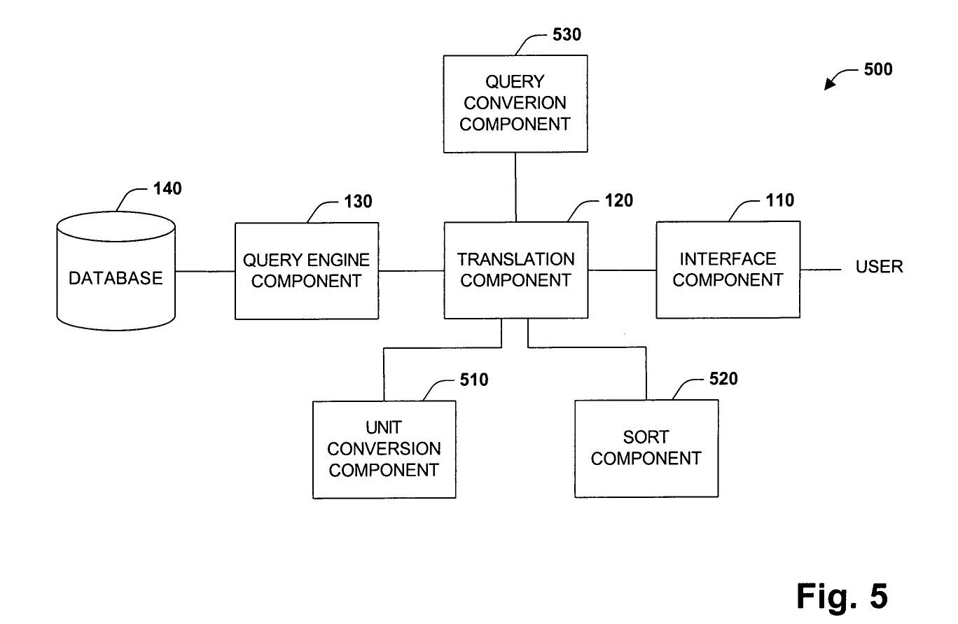

Turning to FIG. 5, a database translation system 500 is illustrated in accordance with an aspect of the subject invention. System 500 includes the same components as system 100 of FIG. 1 such as interface component 110, translation component 120, query engine component 130 and database 140 but also includes unit conversion component 510, a sort component 520, and query conversion component 530. Interface component 110 provides a mechanism for transmitting queries to a database and receiving the resulting data. Translation component 120 receives a query and possibly provides some translation or conversion of the query (described infra) and then passes the query to query engine component 130. Query engine component 130 executes a query on the database 140 and provides resulting data to the translation component 120. Translation component 120 can then translate the resulting data to a user selected presentation language (e.g., Russian, Italian, German . . . ) and transmits the translated data back to a user via interface 110. Up to this point the present invention has been limited to text translation; however the subject invention is not so limited. It should be appreciated that translation component 120 can also employ a unit conversion component 510 to convert stored units. As previously noted the translation system of the present invention can be run on a default language such as English. Accordingly, measurement values can be in English Standard Units (e.g., foot, pound . . . ). However, if so desired, the system could convert English Standard Units to Metric units (e.g., meter, gram . . . ). To accomplish the foregoing, unit conversion component 510 could apply a function to particular query result values to convert them to the appropriate unit. Similarly, the unit conversion component 510 could be employed to convert currencies. For example, if the system is returning text results in Russian then dollar amounts could be automatically converted to the appropriate amount in rubles at a particular time. Database translation system 500 can also include a sort component 520.

Sort component 520 is concerned with displaying sets of data to a user. As noted throughout this specification, data can be stored in a base or default system language such as English. Query results however can be returned in some other preferred user language (e.g., German, Russian, French, Spanish . . . ) as translated by translation component 120. Accordingly, if a set of data is to be returned sorted, for instance alphabetically, then some mechanism is needed to sort data according to the translated language. Otherwise, data would be returned in the selected presentation language but sorted according to the base system language. Sort component 520 provides a mechanism for properly sorting data. Sort component 520 can receive information regarding how data should be sorted. For example, sort component 520 can receive collation information from a user such as what language to use to sort, ascending or descending order, whether ordering will be case sensitive, and the like. Upon receiving collation information and a query result set, the sort component 520 can sort the data in accordance with the user collation information and present such data to the user.

Database translation system 500 can also include a query conversion component 530. Queries can be provided by users in a variety of formats. For example, the query can be a regular structured query in the database system base language, a structured query in a language different than the system base language, or a natural language query in either the system base language or some other language. The translation system, however, can be much stricter and can mandate one particular format to facilitate execution of a query on query engine component 130. Conversion component 530 can be employed by translation component 120 to act as a bridge between the free form queries that can be specified by a user and a strict system format. In other words, conversion component 530 can convert a user's request or query to a system executable command or instruction. For instance, if a user specifies his request in a structured query language in German and the default system language is English than the conversion component 530 will convert the German query to an English query. Similarly, if a user inputs a natural language request such as “How many widgets did we sell last year” or “ [symbol] Cuántos widgets vendimos el ano pasado?” in Spanish or “Quanti widgets abbiamo venduto l'anno scorso?” in Italian, then such input can be converted by the conversion component 530 to a query of proper syntax in the system base language.

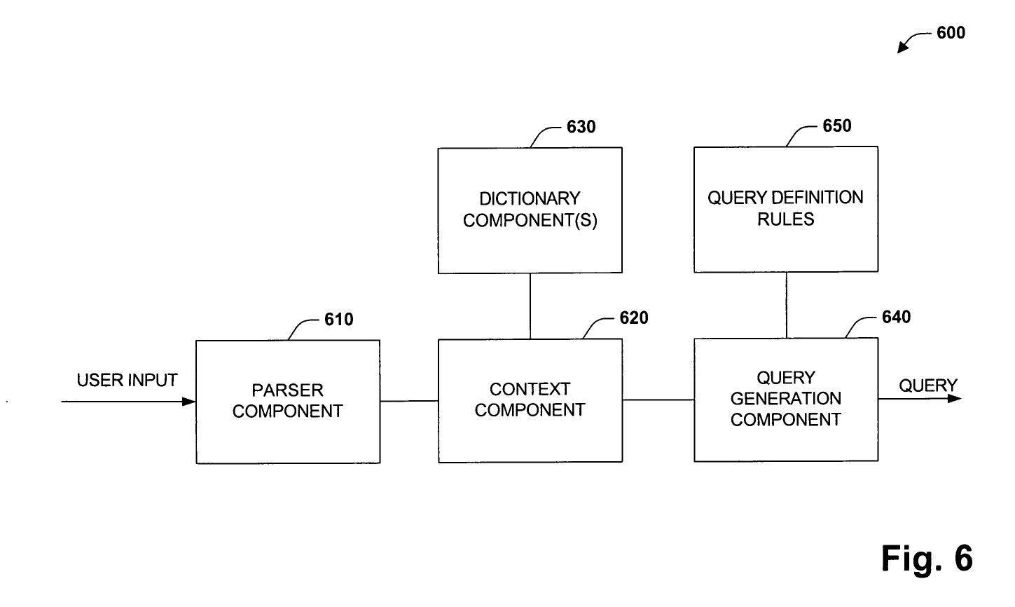

FIG. 6 depicts a query generation system 600 in accordance with an aspect of the subject invention. Query generation system 600 can be employed as part of the query conversion component 530 (FIG. 5). The system 600 can comprise a parser component 610, dictionary component(s) 620, a context component 630, a query generator component 640, and query definition rules 650. Parser component 610 receives a string of text and numbers and parses the string into individual words, number, and other tokens (e.g., punctuation). The parser component 610 can then store these elements in an operable structure of language elements preserving their relations. Context component 620 can contain, retrieve, or receive information regarding the relationships between words, numbers, and other tokens. Dictionary component(s) 630 can contain vocabulary definitions of words, synonyms, and translation information to facilitate translating a language into the base language of the system. Context component 620 receives the structure of language elements from parser component 610 and utilizing the dictionary component(s) 630 constructs a structure that captures the meaning of the text transmitted by a user. For example, such information can be stored as a tagged XML (eXtensible Markup Language) document, where the tags include metadata concerning particular parsed elements (e.g., command, operator . . . ). Context component 620 can then pass the structured data to the query generation component 640. Query generation component 640 provides a mechanism for constructing valid system queries. Query generation component 640 can retrieve information from query definition rules 650. Query definition rules specify the query syntax and semantic information regarding properly constructed queries. Query generation component 640 can construct an executable query based on the structured data received from the context component 620 and query definition rules 650 (e.g., syntax, semantics . . . ). Furthermore, it should be appreciated that this query generation system 500 can also be employed to generate queries in situations where a user specifies a query in proper syntactic and semantic format but in a language other than the base language of the system. In such a situation, the system need only convert the query language to the base system language.

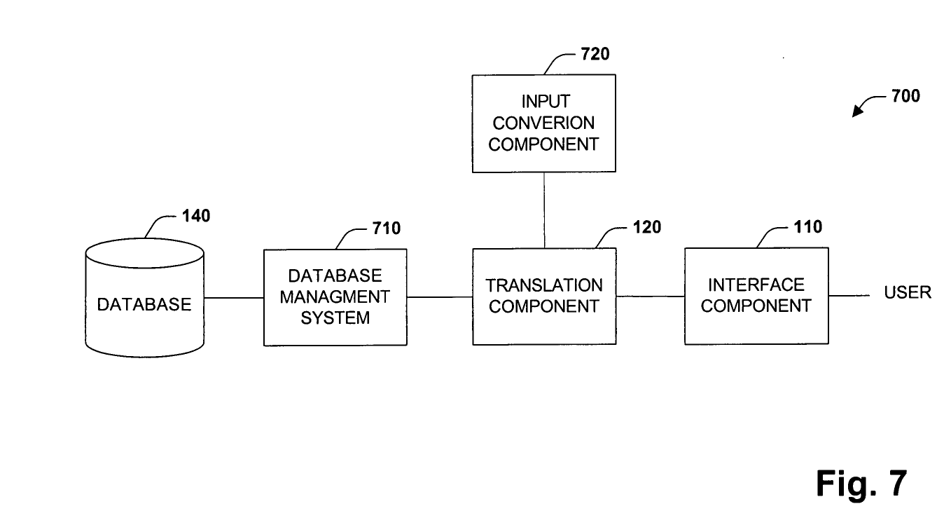

Turning to FIG. 7, a database translation system 700 is depicted in accordance with an aspect of the subject invention. While the present invention has been almost exclusively described with respect to retrieving information from a database, the invention is not so limited. The subject invention also provides for a system 700 for creating, defining, writing or otherwise manipulating database data. System 700 comprises an interface component 110, a translation component 120, a database 140, a database management system 710, and an input conversion component 720. Accordingly, users can input data via interface component 110 using the specific format of a programming language or by simply utilizing a natural language with which they are most comfortable. The translation component 120 can then translate the user input into the base language of the system employing the assistance of input conversion component 720, which operates similar to query conversion component 530 (FIG. 5). Subsequently properly formatted data and/or commands can be provided to database management system 610. Database management system 610 can then receive the data and/or commands and performs one or more operations on database 140 in accordance therewith.

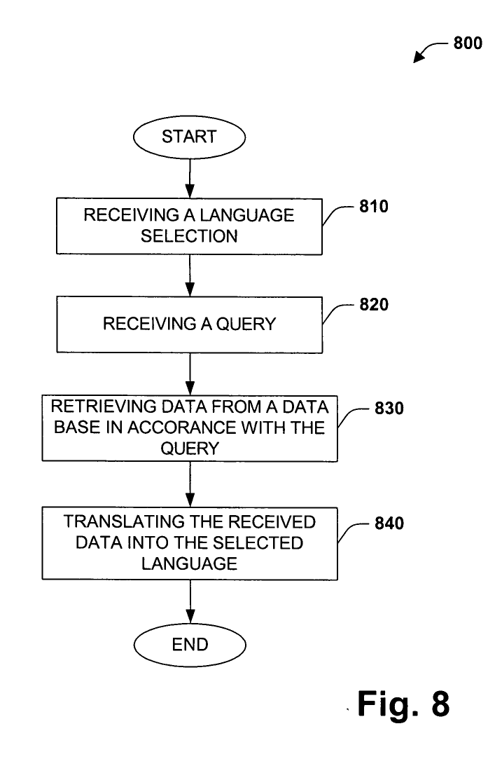

In view of the exemplary system(s) described supra, a methodology that may be implemented in accordance with the present invention will be better appreciated with reference to the flow charts of FIGS. 8-11. While for purposes of simplicity of explanation, the methodology is shown and described as a series of blocks, it is to be understood and appreciated that the present invention is not limited by the order of the blocks, as some blocks may, in accordance with the present invention, occur in different orders and/or concurrently with other blocks from what is depicted and described herein. Moreover, not all illustrated blocks may be required to implement the methodology in accordance with the present invention.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media.

FIG. 8 is a flow chart diagram of database translation methodology 800 in accordance with an aspect of the subject invention. At 810, a language selection is retrieved. The language selection can be retrieved, for example by prompting a user to enter or select a presentation language or automatically by detecting the language being used to enter queries. Additionally, once a language is selected a preference can be set and stored with respect to the particular user such that their preferred language. Upon subsequent employment of the system the preference can be read and the preferred presentation language automatically selected based thereon. At 820, a query can be received. A query can be in the structured query or a natural language query, for example “Sales 12/1995, paper,” or “What were the sales of paper in December of 1995.” Furthermore, both the structured query and the natural language query can be specified in a users preferred language. At 830, resulting data is received from a database or data source in accordance with a query. Such resulting data can be a single value or a table of values, for example. The resulting data can then be translated, at 840, into a selected presentation language (e.g., French, German, Russian, Italian . . . ). Accordingly, if the resulting data is a table or set of data both the metadata such as the column and row names as well as the data can be translated. According to one aspect of the subject invention, translation can be accomplished by referencing or mapping to translation tables that store translations for data and metadata for each of a plurality of languages. Additionally or alternatively, resulting data can be translated dynamically utilizing a context component and one or more dictionary components, for example to infer the correct translation. However, it should be appreciated that if the selected presentation language is English and the base language of the system is English then the process can bypass the translation segment of the process.

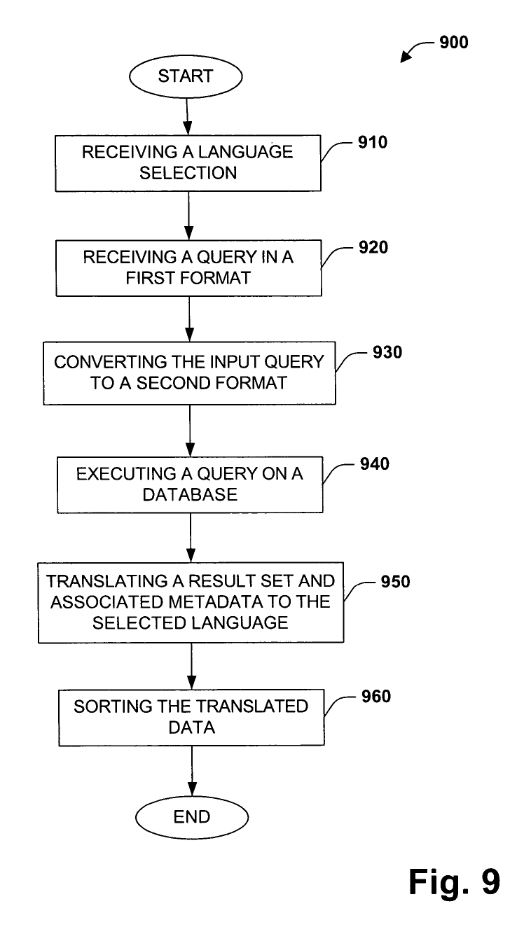

FIG. 9 illustrates a database query methodology 900 in accordance with an aspect of the present invention. At 910, a language selection is made and received indicating a particular presentation language to be utilized. A language selection can be made, for example, by selecting a particular button in a graphical dialog box with a pointing device (e.g., mouse, trackball, stylus, touchpad . . . ) or alternatively language selection can be made automatically by examining the language of an entered query or receiving such information from a local data store associated with a plurality of application programs. Next, a query can be received in a first format at 920. Such a first format can include but is not limited to a structured query in a language different than the system base language and a natural language query in any of a plurality of languages. At 930, the input query is translated to a second language such as the base language of the system (e.g., English) and if necessary converted to proper query format. At 940, the translated query can be executed on a database. Subsequently, a result can be received and translated to the selected language at 950. In particular, both result data and metadata can be translated to the selected language. For example, if the result corresponds to a table then both the column and row labels (i.e., metadata) as well as the actual data in the table can be translated. Finally and optionally, the result data can be sorted. For instance, if a query specified that results were to be returned in alphabetical order than the data should be sorted in accordance with the user's command. However, a question exists as to whether the data should be translated in order in accordance with the base language of the system or the selected translation language. By default the system can sort alphabetically by the system base language, however a user can provide collation information to the system to specify otherwise, such as sorting by the selected language.

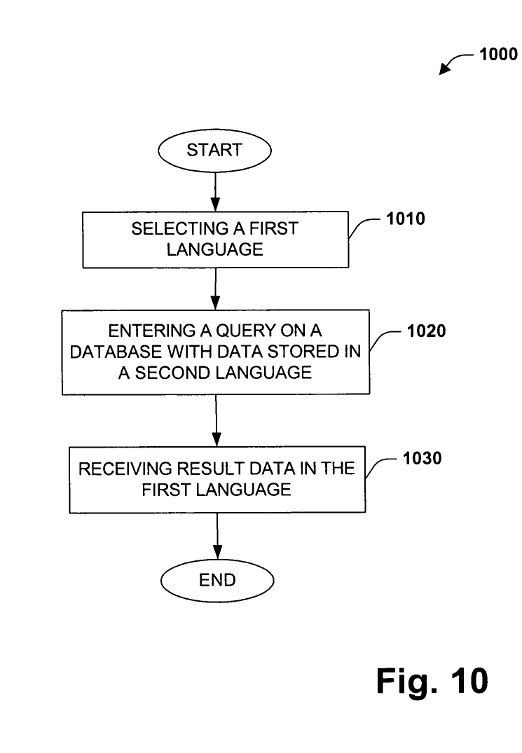

FIG. 10 illustrates a methodology 1000 of interacting with a translation system in accordance with an aspect of the invention. At 1010, a user selects a first language in which to display database query results, for example by selecting a button in a dialog box associated with a particular language. At 1020, a user enters or specifies a query on a database that has data stored in a second language. Accordingly, a user has selected a presentation language that is different than the base language in which the data is stored. For example, a user desires the data to be presented in Russian and the database has data stored in English. Subsequently, at 1030 data is presented to the user in the first language selected.

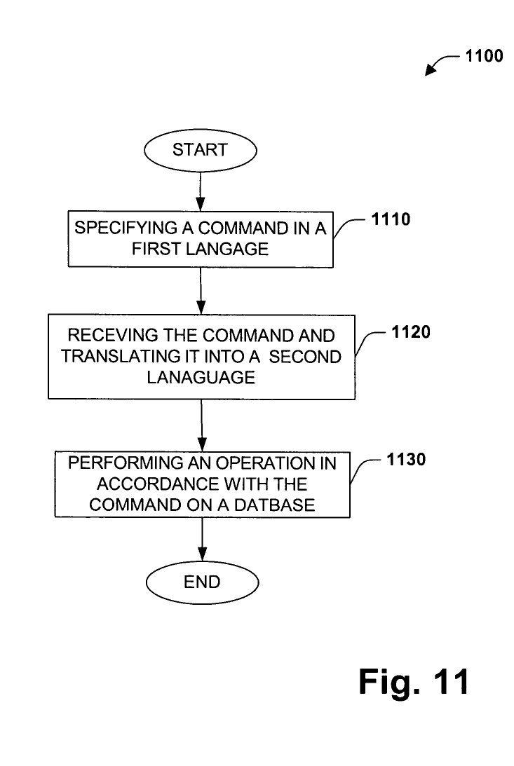

FIG. 11 depicts a method 1100 of interacting with a database in accordance with an aspect of the present invention. At 1110, a command is specified in a first language. A command can correspond to any operation on a database, for example creating or defining a data cube or entering data into a database. The command can be specified in any language desired by a user. Furthermore, the command can actually be in a structured programmatic format or a natural language form. At 1120, the command is received and translated to a second language. For instance, if a command is issued in Russian and the translation system of the present invention utilized English, then the Russian command can be translated into English. Finally, at 1130, the specified command is executed on a database.

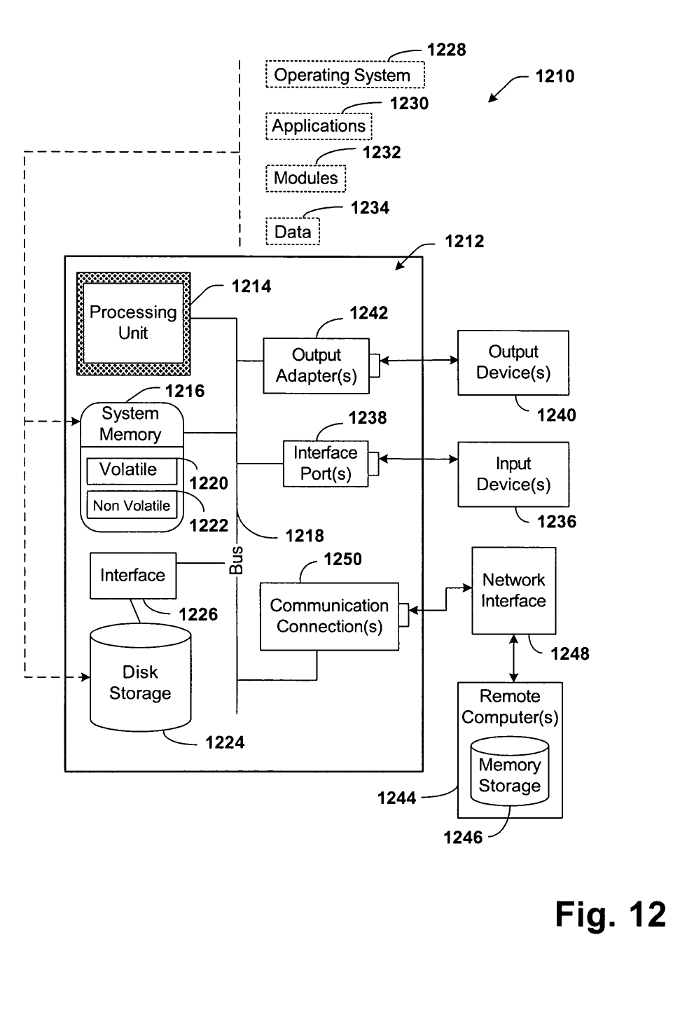

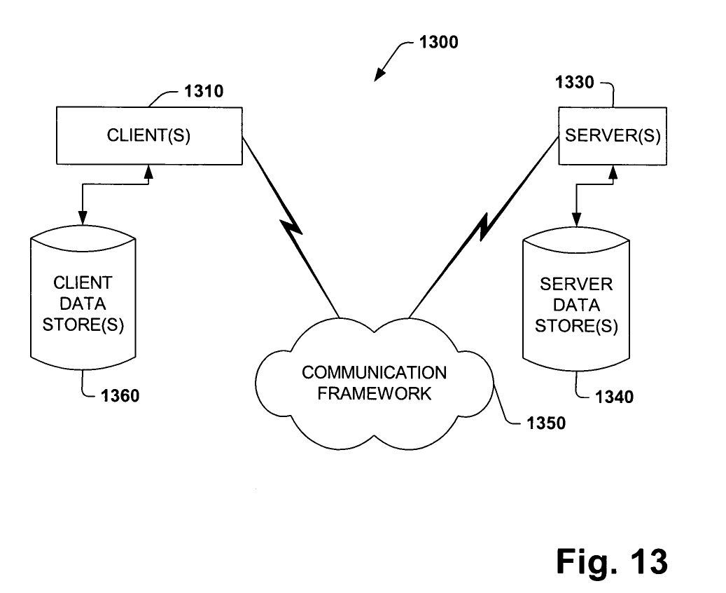

In order to provide a context for the various aspects of the invention, FIGS. 12 and 13 as well as the following discussion are intended to provide a brief, general description of a suitable computing environment in which the various aspects of the present invention may be implemented. While the invention has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices, microprocessor-based or programmable consumer electronics, and the like. The illustrated aspects of the invention may also be practiced in distributed computing environments where task are performed by remote processing devices that are linked through a communications network. However, some, if not all aspects of the invention can be practiced on stand-alone computers. In a distributed computing environment, program modules may be located in both local and remote memory storage devices.

With reference to FIG. 12, an exemplary environment 1210 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/non-volatile computer storage media. FIG. 12 illustrates, for example disk storage 1224. Disk storage 4124 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the present invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240 that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

FIG. 13 is a schematic block diagram of a sample-computing environment 1300 with which the present invention can interact. The system 1300 includes one or more client(s) 1310. The client(s) 1310 can be hardware and/or software (e.g., threads, processes, computing devices). The system 1300 also includes one or more server(s) 1330. The server(s) 1330 can also be hardware and/or software (e.g., threads, processes, computing devices). The servers 1330 can house threads to perform transformations by employing the present invention, for example. One possible communication between a client 1310 and a server 1330 may be in the form of a data packet adapted to be transmitted between two or more computer processes. The system 1300 includes a communication framework 1350 that can be employed to facilitate communications between the client(s) 1310 and the server(s) 1330. The client(s) 1310 are operably connected to one or more client data store(s) 1360 that can be employed to store information local to the client(s) 1310. Similarly, the server(s) 1330 are operably connected to one or more server data store(s) 1340 that can be employed to store information local to the servers 1330.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A data translation system comprising:
an interface component that receives requests for data from a user; and
a translation component that retrieves data in accordance with the requests and returns the data to the user in a specified language.

2. The system of claim 1, the interface component comprising a language identification component that determines the specified language of a user.

3. The system of claim 1, the interface component comprises a conversion component that receives data requests in a plurality of different formats and converts the requests into executable queries on data.

4. The system of claim 3, wherein the request is a structured query in the user's preferred language.

5. The system of claim 3, wherein the request is a natural language request.

6. The system of claim 1, wherein the translation component comprises:
one or more translation tables; and
a mapping component that maps retrieved data to its corresponding translation in a translation table.

7. The system of claim 6, wherein the translation tables are set up by a database administrator.

8. The system of claim 1, the translation component comprising and inference component that can translate result data into one or more languages.

9. The system of claim 8, the inference component including a context analyzer component and a dictionary component to facilitate data translations.

10. The system of claim 9, wherein the context analyzer receives metadata associated with result data.

11. A database translation system comprising:
an interface component to receive queries;
a translation component that retrieves analytical data from a database in accordance with a query and translates the resulting data into one or more user languages.

12. The system of claim 11, wherein the queries are specified in a different language than a base language associated with the database.

13. The system of claim 11, wherein the queries are specified in natural language.

14. The system of claim 11, wherein the database is a multidimensional database.

15. The system of claim 11, wherein the translation component comprises a mapping component that maps resulting metadata and data to translations a translation table.

16. The system of claim 15, the translation table being set up and managed by a database administrator.

17. The system of claim 11, wherein the translation component comprises an inference component and dictionary component to dynamically generate data translations.

18. The system of claim 11, further comprising a sort component that receives collation information from a user a sorts resulting data in accordance with the collation information.

19. The system of claim 18, wherein the collation information includes the language to be used for sorting.

20. An online analytical processing (OLAP) system comprising:
an interface component to receive queries;
a translation component that retrieves data and metadata from a multidimensional database in accordance with a query and translates resulting data and metadata from a system base language into one or more user languages.

21. The system of claim 20, wherein the translation component maps resulting data and metadata to a translation table to produce translated data and metadata.

22. A method of querying a database comprising:
receiving a language selection;
receiving a query;
retrieving data from a database in accordance with the query; and
translating the retrieved data into the selected language.

23. The method of claim 22, wherein a user selects a language by entering a query in a particular language, the selected language being the particular language used to enter the query.

24. The method of claim 22, wherein translating the received data comprises retrieving data from a translation table.

25. The method of claim 22, wherein data is translated dynamically utilizing a context component and one or more dictionary components.

26. The method of claim 22, wherein the query is a natural language query.

27. The method of claim 22, wherein the database is a multidimensional database.

28. A computer readable medium having stored thereon computer executable instructions for carrying out the method of claim 22.

29. A method of translating database data comprising:
receiving a language selection;
receiving a query in a first format;
converting the query to a second format;
executing the query on a database; and
translating received result data to the selected language;

30. The method of claim 29, wherein the first query format is in a first language and the second query format is in a second language.

31. The method of claim 30, wherein the first query format is a natural language query.

32. The method of claim 29, wherein translating the result data comprises mapping data and meta-data to a translation table associated with the selected language.

33. The method of claim 29, further comprising sorting the translated data based on collation properties specified by a user.

34. A computer readable medium having stored thereon computer executable instructions for carrying out the method of claim 29.

35. A method of interaction with a database comprising:
selecting a first language;
entering a query on a database with data stored in a second language; and
receiving result data in the first language.

36. The method of claim 35, the database is a multidimensional database.

37. A computer readable medium having stored thereon computer executable instructions for carrying out the method of claim 35.

38. A method of interacting with a database comprising:
specifying a command in a first language;
receiving the command and translating the command into a second language; and
performing an operation on a database in accordance with the command.

39. The method of claim 38, wherein the command is to store a data in the database.

40. The method of claim 38, wherein translating the command into a second language includes translating a natural language command into a structured command in the base language of the system.

41. A computer readable medium having stored thereon computer executable instructions for carrying out the method of claim 38.
